(19) United States
(12) Patent Application Publication
(10) Pub. No.: US 2005/0018887 A1
(43) Pub. Date: Jan. 27, 2005

(54) Analysing spots in a 2-d array

(76) Inventor: Edmond Joseph Breen, City Berowa (AU)

Correspondence Address: SNELL & WILMER;ONE ARIZONA CENTER, 400 EAST VAN BUREN, PHOENIX, AZ, 850040001, US

(21) Appl. No.: 10/495,840

(22) PCT Filed: Nov. 18, 2002
(86) PCT No.: PCT/AU02/01569

(30) Foreign Application Priority Data
Nov. 16, 2001 (AU) PR 8920

(51) Int. Cl. G06K 9/00; G06F 19/00

(52) U.S. Cl. 382/128; 702/19

(57) ABSTRACT

A method for analysing spots in a gel includes the step of digitally sieving the spots to group them according to their radius. Before digitally sieving the spots a computer means digitises an image of the gel and identifies the spots. A segmentation algorithm is used to digitise the image. The spots are grouped from the smallest radius R₁ which is equivalent to a spot having a diameter of a single pixel up to Rₙ where Rₙ is the diameter of the largest spot in the image with each group being one pixel larger than the last. This process allows a user to analyse the image of the gel according to spot size. One particularly useful application is to remove all the very small radius R₁ spots from the image as these tend to be unwanted protein fragments and by removing these spots or noise from the image improves the quality of the image. This removal of background “noise” improves the accuracy of the excision apparatus to allow it to excise relatively pure samples.

### FIELD OF THE INVENTION

This invention relates to a method for use in analysing spots in a 2-D array, such as an array of macromolecules in a gel.

### BACKGROUND OF THE INVENTION

One dimensional and two dimensional (2-D) gel electrophoresis are common techniques used to separate macromolecules from mixtures of macromolecules such as proteins from plasma samples and the like. In 2-D gel electrophoresis separation is undertaken sequentially through orthogonal axes, the first separation commonly being carried out in an IPG strip, with the second dimension separation being carried out in a gel slab. The macromolecules, typically proteins but which may be any biomolecule such as a lipid saccharide, peptide, glycoprotein, nucleic acid molecule or the like, are present as spots in the gel. The spots have to be removed from the gel and the protein or other macromolecule forming the spot is then identified, for example, by mass spectrometry.

Historically, the spots were excised from the gel by hand using a scalpel. However this process is extremely slow and labour intensive. Subsequently, robotic excision apparatus were devised to remove spots from the gel. However, a number of problems arise when using robotic excision apparatus. One particular problem occurs when spots either overlap or are located very close together. It is very difficult to see bifurcated or overlapping spots with the naked eye. Also, when cutting the robotic excision apparatus often contaminates an excised spot with material from an adjacent spot. A second problem with the existing apparatus is that gels tend to be quite messy and may include numerous small protein fragments and may be difficult for a computer to analyse accurately in order to instruct an excision tool.

The present invention seeks to address and ameliorate the problems of the prior art discussed above.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia or elsewhere before the priority date of each claim of this application.

### SUMMARY OF THE INVENTION

In a first broad aspect the present invention provides a method for use in analysing spots in a 2D array such as gel including the step of using granulometry or “digitally sieving” to group the spots according to their radius.

Before digitally sieving the spots it is first necessary for a computer means to digitise an image of the gel and identify the spots. Any suitable image captive means such as a CCD device, frame grabber, digital camera, scanner or the like can be used to image the gel. However, this can be done by the process described in the applicant's pending PCT application PCT/AU02/00656, the entire contents of which are incorporated herein by reference. A segmentation algorithm set out below can also be used to digitise the image.

Typically the spots are grouped from the smallest radius R₁ which is equivalent to a spot having a diameter of a single pixel up to Rₙ where Rₙ is the diameter of the largest spot in the image with each group being one pixel larger than the last.

This process allows a user to analyse the image of the gel according to spot size. For example the computer control means may display an image of the gel on an associated display means. The user may be allow to select the spots to be displayed in the image according to size, for example all spots having a radius greater than R₁ or all spots having a radius less than R₆, or all spots having a radius between two particular radii.

One particularly useful application is to remove all the very small radius R₁ spots from the image as these tend to be unwanted protein fragments and by removing these spots or noise from the image improves the quality of the image. This removal of background “noise” improves the accuracy of the excision apparatus to allow it to excise relatively pure samples.

The information obtained from the analysis of the image may then be used to direct a robotic cutting tool.

### BRIEF DESCRIPTION OF THE DRAWINGS

A specific example of the invention will now be described, by way of example only, and with reference to the accompanying drawings in which:

FIG. 1a is a curve representing a function of an image such as intensity against distance;

FIG. 1b is a schematic illustration of “digital/virtual sieving” carried out on an array of protein spots after they have been identified and characterised by imaging software;

FIG. 2 is a graph showing the cumulative number of spots having particular radii R₁, R₂, . . . Rₙ measured in pixels;

FIG. 3a shows an original gel image;

FIG. 3b shows a cleaned up image of the original gel image 3a;

FIG. 4a shows a notional granulometry curve for an array of protein spots;

FIG. 4b is a derivative of the curve of FIG. 4a; and

FIGS. 5 and 6 show a robotic cutting tool.

### DETAILED DESCRIPTION OF A PREFERRED EMBODIMENT

The present invention uses “virtual” or “digital sieving” or granulometry to pick out the markers in terms of their x-y position on the gel. In the method of present invention, the concept of a granulometry, or size distribution, may be likened to the sifting or rocks in a gravel heap. The rocks are sifted through sieves/screens of increasing size, leaving only the rocks that are too big to pass through the sieve. For each screen size, one records the number and volume distribution of the rocks which have been sifted at that size. The process of sifting the rocks at a particular size, is analogous to the “opening” of an image using a structuring element of a particular size. The residue after each “opening” reveals useful information about the distribution of object sizes in the image. Importantly, in terms of algorithm design, it also allows for the application of a sliding scale so that the user may quickly and easily select a desired size of object to analyse. Granulometry and other image analysis techniques are discussed in a number of papers to which the inventor has contributed the contents of which are incorporated herein by reference, including:
“Image Analysis” by M. Berman, L. M. Bischof, E. J. Breen and G. M. Peden in Materials Forum (1994) vol 18 pp 1-19;
“Attribute Openings, Thinnings, and Granulometrics” by Edmond J Breen and Ronald Jones in Computer Vision and Image Understanding Vol 64., No 3, November, pp 377-389,1996; and
“Mathematical morphology: A useful set of tools for image analysis” by Edmond J Breen, Ronald Jones and Hughes Talbot, published in Statistics and Computing (2000) Volume 10, pp 105-120.

However, before “digitally sieving” an image of a gel, the image first has to be captured and digitised. A scanner records an image of a 2-D gel and transfers that data to a computer running imaging software incorporating a segmentation algorithm which is set out below. The algorithm extracts the image regions according to size.

These regions then identify the individual proteins and their position in the gel. The approach also maximises the area of the gel spot that can be excised from the gel for any spot that without cutting into overlapping gel spots. In order to maximise the gel spot area that can be excised for protein purity, the algorithm readjusts the centre or marker position for each spot as the spot area grows. The protein spots may then be excised from the gel by a robotic cutting tool directed to particular x, y locations on the gel by control means running the image analysis software of the present invention. International Patent application No PCT/AU02/00655 of which the present applicant is a co-applicant entitled “Sample collection and preparation apparatus” the entire contents of which are incorporated herein by reference describes one apparatus for excising macromolecule spots, typically protein spots from a gel.

Because the size of all the gel spots is measured simultaneously, thresholds can be chosen dynamically on the basis of position, size, intensity and/or shape.

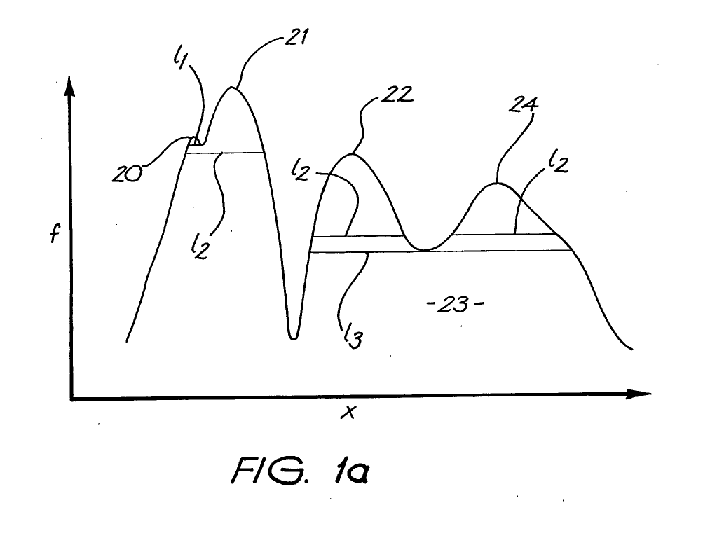

By way of explanation, FIG. 1 (not to scale) schematically illustrates a section or slice through a topological surface representing a digitised image of an array of spots. If a line having a certain number of pixels say N fits under the curve then that part of the curve, fits into the “N pixels” sieve. Lines I₁, I₂ and I₃ of varying pixel length are shown. Clearly some “spots” will be in many sieves. I₁ is a short line of only a few pixels. I₂ is much longer and I₃ is longer still. The process may be used to remove the blip 20 on peak 21 as “noise” depending on the cut off length in pixels for removing noise, and to identify that spot 23 is in fact a “double” or bifurcated spot made up of two peaks which may be significant, none of which would necessarily be obvious to even a skilled worker viewing a simple image of the gel. This information can then be used to direct the cutting tool to excise the spots 22 and 24 separately. Other useful information may be provided by the granulometry such as distribution of spots of different sizes, average spot size etc.

Of course the process schematically illustrated in FIG. 1a, has to be carried out “slice by slice” for the entire image of the array. If the surface is viewed as a topological surface, rather than a series of slices of that surface, thresholds other than lines could be used, for example, shapes such as circles or area can be used to “sieve” the curve rather than lines.

FIG. 1b schematically illustrates the “digital/virtual sieving” that is carried out on the spots after they have been identified and characterised by imaging software as described above. Typically the spots are grouped from the smallest radius R₁ which is equivalent to a spot having a diameter of a single pixel up to Rₙ where Rₙ is the diameter of the largest spot in the image with each group being one pixel larger than the last.

Returning to FIG. 1 it can be seen that each of the spots may be grouped by radius with the smallest spots having a radius of R₁ in one sieve 10, the spots having a radius of R₂ (two pixels) in a second sieve 12 and so on with the largest virtual sieve spot having a radius of Rₙ in the largest pore size sieve 14. Note that some spots may be in many groups.

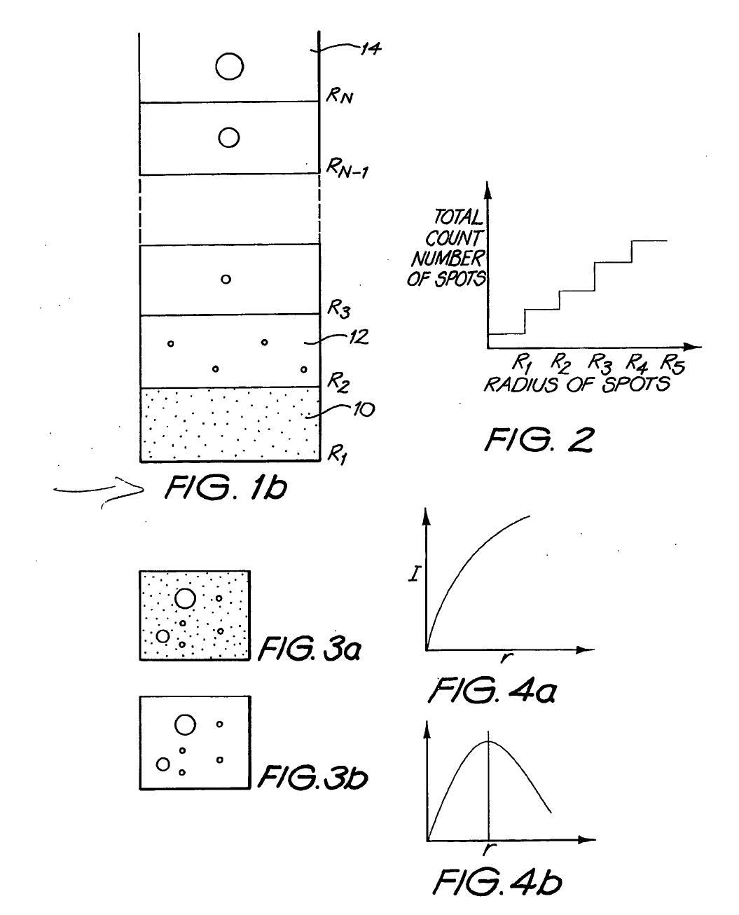

FIG. 3 is a graph showing the cumulative number of spots having particular radii R₁, R₂. Rn measured in pixels.

The digital images of the gel may be displayed on a display screen and manipulated to select the spots to be displayed in the image according to size. For example all spots having a radius greater than R₁ or all spots having a radius less than R₆, or all spots having a radius between two particular radii. Figure shows an image of a gel in which all the spots are displayed. FIG. 4b shows a cleaned up image in which only the spots having a radius greater than R₁ are displayed. This effectively removes the unwanted information or “noise” from the image.

Set out below is an algorithm for “segmentation” for locating the centres of spots in images of gels, together with brief explanation of each of the steps.

1. Construct a greyscale image “I” from the image “input”
If “input” is a 3 component colour image R (red), G (green), B (blue), then I=G
Otherwise: I=the first component of “input”

This stage involves the construction of a grey scale image. If the image is a 3 component colour image R (red), G (green), B (blue) then the green band only is taken and the red and green discarded. The reason for this is that the green band provides the most useful information about the spots in the image. The blue band contains the most noise and the red band does not contain much information. The red and blue bands also suffer more from chromatic aberrations, hence it is best to discard those bands.

2. Construct a top hat image “T” to remove the background from the image
C=Morphologically closing of an image “I” using a 12 sided polygon
T=C−I

In this step, the background which does not contain any information of interest, is removed from the image.

3. Construct granulometric images “Gi” from N different increasing area size values Si={S1, S2, . . . SN}
OSi=Open the image ‘T’ using an opening by attribute with area size value “Si”
Bi=T−OSi>0
STi=Size transformation on the binary image Bi
SRi=Regional maxima in the image STi
Gi=SRi>t, where t is a specified threshold

This step digitally sieves the image according to pixel size.

4. Combine the granulometric images “Gi” to obtain a seed image “M” of spot markers
M=MAX {Gi*i}, whereiin{1 toN}

Steps 5, 6, 7 and 8 are all ways of analysing the information produced by granulometry.

5. Remove noise and label the seeds to produce a labelled image “L”
O=Open the image “M” using an opening by attribute with a specified area threshold
RM=regional maxima in the image “0”
BM=RM>0
L=label the objects in the image BM

In this step the noise is removed by specifying a minimum size in pixels for a spot, say 10 pixels and removing all spots which have a pixel size of less than 10 pixels.

6. Remove labelled objects in the background of the image
LB=L*BN, where BN is the image produced in Step 3 using size values Si=SN

In this step, if we know the size of the largest spot in the array or know the size of the largest spot we expect to see in the image, or are interested in, we can filter out the background of the image by filtering out any image bigger than that size.

7. Perform “perculation” on the labelled objects in LB by growing out the labelled objects
P=perculate LB, using image “T” and a specified percolation level
R=P>0

Step 7 of the algorithm grows up all spots from their markers simultaneously, but naturally separates out any overlapping regions as no two spots can share the same pixel. We can use this process to handle “double spots” or bifurcations such as spot 23. The minimum distance between spots can also be controlled dynamically in the algorithm so as to maximise spot separation but at the same time maximise the amount and purity of the protein sample that can be excised from any adjacent spot.

8. Label and compute the centre points of the objects in the result image “R”
L=label objects in “seeds” using 8 connectivity
C=centroids of the objects in L
Output is:
   a file containing the (x, y) centroids, which have been processed so that they are a specified minimum distance apart and lie within the objects in the image “R”
   the binary image “R” containing the boundaries of the spots found in the input image. The algorithm provides the gel cutting tool with a list of positions and sizes of gel spots that may be required to be excised from the chromatogram.

Using granulometry it is possible to analyse the images of the protein spots in the array to determine useful information such as the average diameter of the spots in the array. For example, FIG. 4a shows a notional granulometry curve for an array of protein spots, and FIG. 4b is a derivative of that curve illustrating at its maximum, the most common spot size. The steepness of the curve 4a gives an indication of the size of the spots in the array, a steep curve indicating that the gel contains lots of small spots.

As discussed above, granulometry can also be used to locate bifurcations. Once the information on the image has been obtained and assigned to the various groups, remembering that one spot may be in many groups or “bins”, the information may be used to “grow” the spots up, and for example identify bifurcations two spots join or merge defining two distinct peaks.

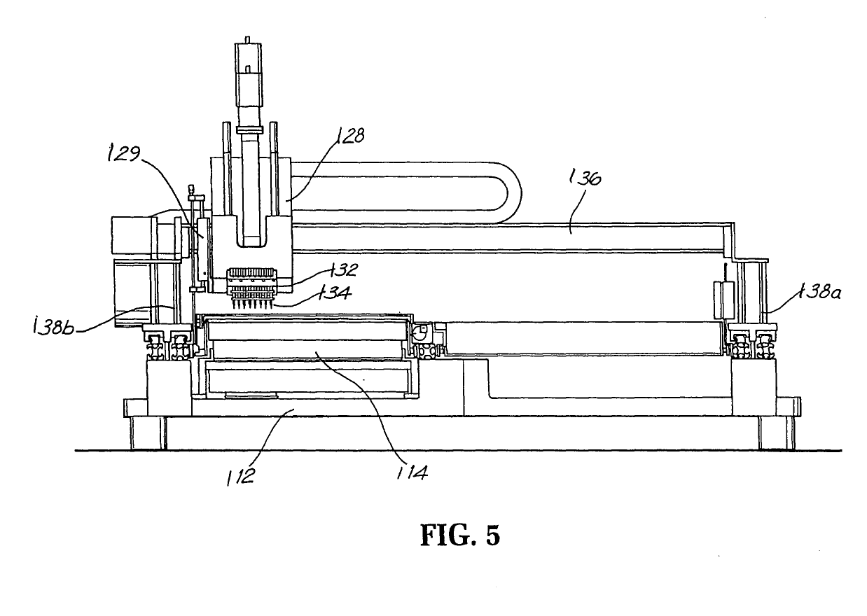

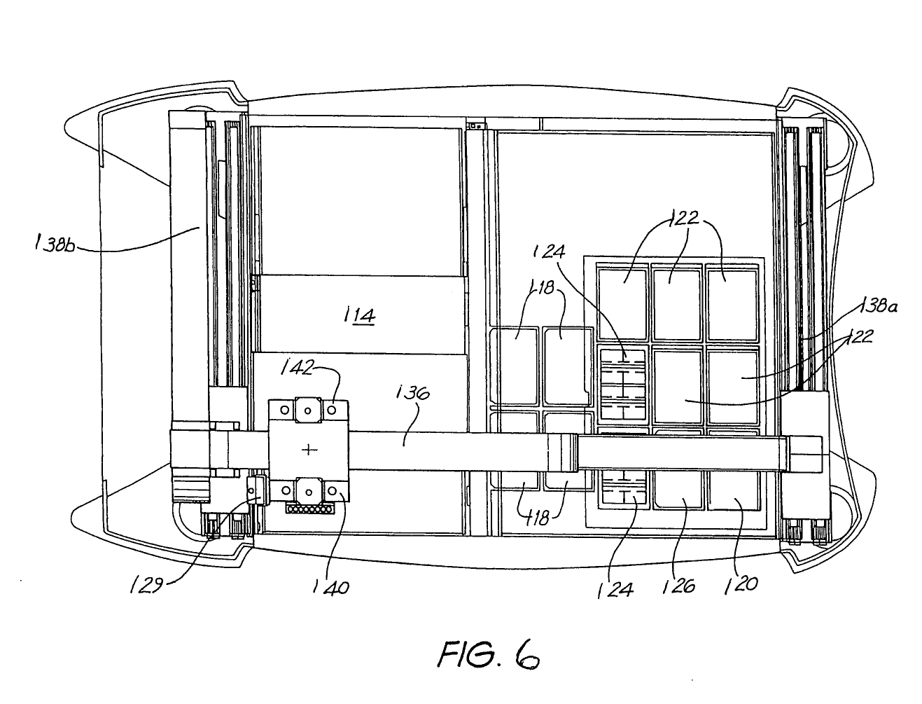

FIGS. 5 and 6 show a cutting apparatus which can be a controlled by a computer control means running software embodying the algorithm set out above and generally indicated at 110 includes a chassis 112 on which a scanner 114 is supported. The scanner may be a high resolution “desktop” type scanner and includes a glass table 116 above which a two dimensional array of biomolecules such as proteins in a gel or supported on a membrane can be placed. Adjacent the scanner, there are four microtitre plates (MTPS) 118, a 384 well MALDI target plate 120, boxes 122 containing pipette tips and/or “zip tips” 30, trays 124 containing various solvents and reagents and a 384 well MTP 126 containing purified water.

Mounted for movement above the scanner, is a machine head 128 including a cutting tool 129 and an eight channel liquid delivery means 132 including eight adjacent liquid delivery outlets 134. The machine head moves along an X axis 136 which in turn extends between and is supported by two Y axes 138a, 138b. The machine head includes a Z axis driver 140 for driving the cutting tool up and down in a vertical direction and a parallel W axis 142 for driving liquid delivery means. Thus, the machine head can move not only in mutually perpendicular horizontal X and Y directions parallel to the surface of the base frame, but can also move in the vertical Z direction so that a specified portion of an array supported on the glass table 116 can be cut and picked up by the cutting tool 129. The machine head may also be moved so that liquid delivery tips 130 carried by the liquid delivery outlets 134 are positioned to aspirate reagents/solvents from the solvent trays 124 or MTP 126 and to dispense the aspirated reagents/solvents onto samples which have been excised from the gel and placed in microtitre plates 118. It is also possible to dispense reagents onto the samples in situ in the gel. The vertical height of the tips 30 is also controlled by the Z axis. The computer control means, not illustrated, controls the operation of the apparatus and in particular, the movement of the cutting tool.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method for use in analyzing sports in an array including the steps of:
using a computer to digitize an image of the gel; and
applying granulometry to produce granulometric images for N different increasing size values Sᵢ for a given size attribute, by
(a) opening the image at each size Sᵢ to produce opened images, and then
(b) obtaining the pixel differences between sequential opened images to identify the image regions within the size range Sᵢ to Sᵢ₊₁.

2.-11. (Cancelled)

12. The method as claimed in claim 1 wherein the size attribute is radius and the spots are grouped from the smallest radius R₁ which is equivalent to a spot having a diameter of a single pixel up to Rₙ where Rₙ is the diameter of the largest spot in the image with each group being one pixel larger than the last.

13. The method as claimed in claim 1 including the step of displaying an image of the array on a display and allowing a user to select the spots to be displayed in the image according to the size of the spots.

14. The method as claimed in claim 13 wherein the step of displaying an image of the array involves displaying all spots having a radius greater than a predetermined value.

15. The method as claimed in claim 13 wherein the step of displaying an image of the arrange involves displaying all spots having a radius less than a predetermined value.

16. The method as claimed in claim 13 wherein the step of displaying an image of the array involves displaying all spots having a radius between two particular predetermined values.

17. The method as claimed in claim 16 including the steps of identifying bifurcations in the image of the array.

18. The method as claimed in claim 1 including the step of using data obtained by the method to direct a cutting tool to excise one or more spots in the array.

19. The method according to claim 1 wherein subsequent to digitizing an image of the array, the image is segmented to identify the non-background pixels by applying thresholding.

20. The method as claimed in claim 1 including the step of identifying seed points and identifying image regions associated to each seed point.

21. The method as claimed in claim 1 wherein the spots are present as macromolecules in a gel.

22. A method for use in analyzing spots in an array including the steps of:
using a computer to digitize an image of the gel; and
applying granulometry to produce granulometric images for N different increasing size values Sᵢ for a given size attribute, by
(a) closing the image at each size Sᵢ to produce closed images, and then
(b) obtaining the pixel differences between sequential closed images to identify the image regions within the size range Sᵢ to Sᵢ₊₁.

23. The method as claimed in claim 22 wherein the spots are present as macromolecules in a gel.

24. The method as claimed in claim 22 wherein the size attribute is radius and the spots are grouped from the smallest radius R₁ which is equivalent to a spot having a diameter of a single pixel up to Rₙ where Rₙ is the diameter of the largest spot in the image with each group being one pixel larger than the last.

25. The method as claimed in claim 23 including the step of displaying an image of the gel on a display means and allowing a user to select the spots to be displayed in the image according to the size of the spots.

26. The method as claimed in claim 25 including the steop of using data obtained by the method to direct a cutting tool to excise one or more spots in the array.

27. The method according to claim 22 wherein subsequent to digitising an image of the gel, the image is segmented to identify the non-background pixels by applying thresholding.

28. The method as claimed in claim 22 including the step of identifying seed points and identifying image regions associated to each seed point.
